(19) United States
(12) Patent Application Publication
(10) Pub. No.: US 2007/0203821 A1
(43) Pub. Date: Aug. 30, 2007

(54) Computer system, method and software capable of listing identified goods in transit or storage and managing buyer and seller communications regarding such goods

(76) Inventor: Remi DuFour, Foster City, CA (US)

Correspondence Address: J. G. Mullins;Ste. 304, 1618 East Gate Way, Pleasanton, CA, 94566, US

(21) Appl. No.: 11/516,690

(22) Filed: Sep. 5, 2006

Related U.S. Application Data
(60) Provisional application No. 60/776,368, filed on Feb. 24, 2006.

(51) Int. Cl. G06Q 40/00

(52) U.S. Cl. 705/37

(57) ABSTRACT

The present invention provides an improved network computer and communication system permitting sellers to list identified goods in transit or identified goods in storage on a network buyer and seller introductory forum further providing a communication management system for managing certain communications between sellers and potential buyers with respect to such goods, wherein the computer system is loaded with at least one software module having logic permitting anonymous or identifiable sellers to register and list such goods identified by a specific transit container or specific storage container number, or a number uniquely attached to the goods and able to indicate current, future and past location or any combination of thereof on the network buyer and seller forum, and the computer system is further loaded with at least one software module having logic permitting anonymous or identifiable registered buyers to compete for purchase of such goods. In on embodiment, neither the buyer or seller are identified within the buyer and seller forum other than by a transitory identification number until the seller has selected and paid, or agreed to pay, the forum providers for contact information of one or more potential buyers to further consider one or more offers by one or more potential buyers.

### FIELD OF THE INVENTION

The field of the present invention relates generally to an improved network computer and communication system permitting sellers to list identified goods in transit or identified goods in storage on a network buyer and seller introductory forum further providing a communication management system for managing certain communications between sellers and potential buyers with respect to such goods, wherein the computer system is loaded with at least one software module having logic permitting anonymous or identifiable sellers to register and list such goods identified by a specific transit container or specific storage container number, or a number uniquely attached to the goods and able to indicate current, future and past location or any combination of thereof on the network buyer and seller forum, and the computer system is further loaded with at least one software module having logic permitting anonymous or identifiable registered buyers to compete for purchase of such goods. In a preferred aspect, neither the buyer or seller are identified within the buyer and seller forum other than by a transitory identification number until the seller has selected and paid, or agreed to pay, the forum providers for contact information of one or more potential buyers to further consider one or more offers by one or more potential buyers.

### BACKGROUND OF THE INVENTION

Traditionally, goods in transit or goods in storage are sold to buyers in one of two major ways. Either sellers of such goods directly locate a buyer from their own contacts or listings of potential buyers, or the sellers use the services of exclusive or non-exclusive goods brokers (wholesalers or distributors) who negotiate with the seller to set minimum prices for the goods, a commission rate, or both prices and commission rates and then brokers locate one or more buyers for such goods.

In the first case, sellers must employ staff and keep contact information of past buyers or purchase a list of potential future buyers to directly locate potential buyers, which adds to sellers' overhead costs. This can reduce profits for the sale of such goods due to personnel costs, computer or hard file systems to maintain buyer lists, and communication costs for communications with potential buyers who may not have a current need for such goods. Often sellers feel that it is necessary to negotiate a sales price and quantity with a buyer and set up an option contract before the seller even purchases the goods, where the sales price and quantity available are based upon an estimated seller cost for the goods that may be higher or lower than the estimate and goods may not even be available to meet a buyer's needs and quantities timetable. Sellers can incur legal costs if the option contract cannot be fulfilled at the negotiated quantity, price and delivery schedule. In addition to these problems that can lead to advance costs, other expensive procedures are sometimes necessary in order to reduce the likelihood of needing to store perishable or short demand goods and in order to reduce warehousing costs for storing and securing goods.

In the second case, sellers of such goods indirectly locate a buyer by using the services of exclusive or non-exclusive goods brokers (wholesalers or distributors) who negotiate with the seller to set minimum prices for the goods, a commission rate, or both prices and commission rates and then brokers locate one or more buyers for such goods. Finding a good broker can cost money, take time, and limit the seller to only potential buyers for which a particular broker has contact information. Other potential buyers, who might be willing to pay an even higher price for the certain goods, may not be on a broker's list. Also, brokers may work with many clients, and unless a seller is willing to give the broker an exclusive sales contract, the broker may not spend as much time as a seller would like or get the best price for the seller. Brokers must also employ staff and keep contact information of past buyers or purchase a list of potential future buyers, which adds to a broker's overhead costs and increases the necessary commission rates that brokers need to charge sellers for their services. To protect their interests, such brokers do not typically identify potential buyers to the seller prior to settlement of the purchase and must spend time contacting potential buyers and sellers to work out shipping and handling costs, deliver times and other details that can take time and reduce profits for both brokers and sellers.

Because of the above issues, often a seller cannot feel comfortable to take advantage of available, low cost goods before securing a potential buyer. Also, potential buyers cannot reliably locate actual goods in transit or actual goods stored nearby that can be redirected or shipped quickly to the potential buyer to meet immediate needs of the potential buyer. Also, the above system can reduce the amount of available goods, due to risks of sellers being stuck with goods for long storage periods or until some goods perish and become worth less or completely worthless.

One solution might be a classic auction, such as eBay where goods are posted for sale. However, as many auction buyers have learned, such goods may not be available or even exist in the hands of a seller at the time of purchase. The buyer does not know if the listing is that of a retailer who has a contract with a wholesaler to only order goods after a buyer purchases. A refund of the amount paid for unavailable goods does not help a buyer, if the buyer needs to resell the goods to a third party after a quick delivery. Since goods are not required to be specifically identified, they may not exist and a firm shipping date may not be readily available to the buyer. Also, a seller must sell to the highest bidder at the end of a set time period, which may not be the most profitable sale. Either the time may be too short or the shipping may cost more for either the buyer or seller. If the seller has agreed in advance to pay for shipping, the second highest bidder may have been a more profitable sell . . . had the seller only known the location of the potential buyer. Also, the location of the seller may not be available to the buyer in order for the buyer to reliably calculate shipping costs that would provide the buyer with the goods within the buyer's preferred delivery schedule. Thus, the auction listing time constraints and the inability to locate where goods are, where the seller is, and where the buyer needs deliver, can all add to the cost and complications for both buyer and seller.

At the present time, there does not exist any entity with a network computer and communication system, which provides buyers and sellers with an open market place for Merchandise in Transit (MiT) that also provides a systematic listing of container ID numbers or other specific identifiers for MiT. Instead, as discussed above, MiT are typically directly or indirectly traded over the telephone within limited circles of business relations, with limited views for both buyers and sellers as to what is going on in other places, and with parties being restricted therefore to limited choice for buying and selling.

Accordingly, there is a strong need for an improved network computer and communication system that will permit sellers to list identified goods in transit or identified goods in storage on a network buyer and seller introductory forum further providing a communication management system for managing certain communications between sellers and potential buyers with respect to such goods. There is a definite need for potential sellers to be able to quickly locate a narrow field of very interested buyers seeking goods at sellers target sales price, for sellers to be able to determine the most profitable sale for their goods, for sellers to be able to obtain contact information for one or more buyers from that narrow field of potential buyers, and then conclude the most profitable sale. There is a strong need for such a network buyer and seller forum where a seller of goods can first purchase bargain price merchandise that is in transit or storage in a shipping container with an identifiable container number, and then list such merchandise on the buyer and seller forum for a potential resale. This would permit a seller to obtain bargain merchandise (goods) already in transit or about to be shipped, or in storage, to list the identified goods on the forum with a different itinerary or the original, to resell the merchandise to a buyer with the lowest shipping costs, highest price quote, or both, and to even redirect goods from a first shipping destination to a second destination of a buyer to provide goods to the buyer in a short amount of time.

### DEFINITIONS

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Anonymous” as used herein with respect to buyers and sellers within a goods listing and buyer/seller introductory forum, means the omission of one or more types of name or contact information from references to a buyer or seller within a seller goods listing and buyer/seller introductory forum, where such information would be necessary for a party who is using the buyer and seller forum to have in order to contact one another. Ideally, in such a forum, a name or contact information item associated with a buyer or seller ID must be disclosed by the forum or the person seeking to make a contact must independently obtain the name or contact information outside the forum in order to contact the buyer or seller associated with the ID utilized within the forum to minimize contacts of buyers and sellers except through the forum procedures.

“Buy Offer Quote” and “BOQ” refers to an anonymous offer to buy specifically identified goods that are listed in a buyer and seller introductory forum, which may be characterized by any of the terms bid, offer (note that the word “offer” by itself is loosely used and is usually what the seller asks for in traders' parlance) or quote and the seller has the absolute right to refuse or to accept the BOQ. Unlike a traditional auction, in a buyer seller introductory forum according to the invention, the seller is not required to set a minimum acceptance price or to accept the highest bid, offer or quote at the end of a set period of time (auction length). This is different from a traditional auction that would require a seller to automatically accept the highest bid when the auction time expires and would result in a sales contract between the buyer and seller participating in the auction.

“Closed Performance Record” and “CPR” interchangeably refer to a goods listing and associated BOQ listing(s) on a buyer and seller forum, where the buying record, selling record, or both are unavailable to some or all users of the goods listing forum.

“Closed BOQ Listing” and “CBL” interchangeably refer to a goods listing forum where buy offer quotes from buyers are not public listing(s) available for viewing by other buyers, other sellers or potential buyers on a buyer and seller forum, and are only available to the listing seller, who can choose whether or not to contact the buyer associated with a particular BOQ.

“Disclose ID” and “DID” both refer to a link, button, or other interface where a seller can request and obtain contact information for a specific buyer who has placed a BOQ for listed goods that are identifiable to a buyer, for example, where such goods are in transit, are in storage, have title papers, or are scheduled to be produced and can be specifically identified upon production (see GIT System below for other means of identifying listed goods).

“Disclosed ID List” and “DID List” both refer to a seller's list of BOQ's where the seller has requested (or is required to request) and obtained contact information corresponding to a buyer who has placed a specific BOQ.

“Delivery Price Offer” and “DPO” both refer to a buyer's BOQ where the amount of the quote is to also cover the cost for delivery of goods to a specified location. Such a quote includes at least the purchase price and the shipping costs, but may also specify other costs, (such as customs and handling costs) as being included in the quoted amount.

“GIT System” refers to a local or distributed network computer and communication system permitting sellers to anonymously list specifically identifiable goods, for example, commercial container goods, titled goods, warehoused goods, manufacturer serialized or numbered goods . . . (such as goods that are already produced or goods scheduled to be produced with those specific serial numbers by a given date), or transit papered goods. An example of serialized or specifically identified goods are goods that are identified by an order or invoice that are scheduled to be made according to a specification to have a particular serial number or order number, where each item scheduled to be made will be specifically identified within a “just in time” (“JIT”) production system (an example would be DELL computers online orders assembled with a particular configuration and software setup). In a preferred aspect, the GIT System relates to goods that are identified by an identifier that can be used to retrieve directly or indirectly at least two of the following locations for the goods: past location, current location and at least one scheduled future location.

“Merchandise in Transit”, “MiT”, “Goods in Transit” and “GiT” all refer to identifiable goods in transit that can be identified by one or more of shipping papers, a commercial container number, shipping vessel (such as a ship, plane, train car or truck) and a mobile shipping unit number. The definitions of merchandise or goods in transit may include empty identifiable shipping containers themselves.

“Merchandise in Storage”, “MiS”, “Goods in Storage” and “GiS” each may interchangeably refer to identifiable goods in storage that can be identified by one or more of shipping papers, a commercial container number, and a mobile shipping unit number. Alternatively, they may be identifiable by a warehouse inventory bin number. The definitions of merchandise or goods in storage may include empty identifiable shipping containers themselves.

“Open Performance Record” and “OPR” interchangeably refer to a goods listing and associated BOQ listing(s) on a buyer and seller forum, where the buying record, selling record, or both can be obtained by all, or some, buyers or sellers accessing the forum by clicking on the ID or by otherwise following forum procedures for obtaining such record or records from the forum as an automatic or premium part of the listing forum.

“Priority Purchase BOQ” and “PPB” interchangeably refer to a priority buy offer quote (BOQ), or an associated system procedure for handling the PPB, for a particular goods listing where a seller is required to add the PPB to their DID List before adding any DIDs of other BOQs listing(s) to their DID list, in order to ensure that a particular buyer will have proper consideration of their Priority Purchase BOQ by the seller associated by the listing.

“Public BOQ Listing” and “PBL” interchangeably refer to a goods listing forum where buy offer quotes from buyers are public listing(s) available for viewing by other buyers, other sellers or potential buyers on a buyer and seller forum, and are also available to the listing seller, who can choose whether or not to contact the buyer associated with a particular BOQ of the listing.

“Shipping Included Price” and “SIP” both refer to either a seller or buyer price term which term covers the purchase price and the shipping costs of the goods to a particular location.

“Transitory ID System” and “TID System” each may interchangeably refer to the use of a dynamic identification (ID) system for buyers and sellers that is unique to a particular listing in a buyer and seller introductory forum in order to avoid re-use of an ID for buyers and sellers that could result in extraneous negotiations outside of the DID List system.

### SUMMARY OF THE INVENTION

An object of the present invention is to provide an improved local or distributed network computer and communication system permitting sellers to list identified goods in transit or identified goods in storage on a network buyer and seller introductory forum further providing a communication management system for managing certain communications between sellers and potential buyers with respect to such goods, wherein the computer system is loaded with at least one software module having logic permitting anonymous or identifiable sellers to register and list such goods identified by a specific transit container or specific storage container number on the network buyer and seller forum, and the computer system is further loaded with at least one software module having logic permitting anonymous or identifiable registered buyers to compete for purchase of such goods.

In a preferred object of the above invention, neither the buyer or seller is identified by the buyer and seller forum other than by a transitory identification number until the seller has selected and paid the forum providers, or agreed to pay, for contact information of one or more potential buyers to contact potential buyers for further consideration of one or more offers by one or more potential buyers.

A preferred object of the invention is to provide such a system, listing and communication forum, that may be referred to as a GIT System, wherein GIT provides a computer system, communication system, and network having the ability to collect, organize, and present offers and bids in a listing forum for Merchandise in Transit (MiT) from registered system users who are potential buyers and sellers. In a more preferred object, first time registration with the GIT System can be opened to anyone who agrees to follow the forum rules in order to expand the number of potential buyers and sellers that can use the forum, and the GIT System may use the internet as an interface with its users, but may also use other platforms available in the future that provide convenience to users, such a portable communication devices' operating systems and the like.

Another object of the invention is to provide such a GIT System as described above, which focuses largely on MiT, which can be thought of as merchandise to be soon placed or is already placed in shipping containers with a shipping company for transport to final destination where the merchandise and container are identifiable by a unique ID number. In a more preferred object, the presence of an ID number is central to preferred GIT system services. By focusing on merchandise with IDs and presenting those IDs in the offerings, this GIT System can ensure potential buyers that the merchandise offered for sale in the GIT System buyer and seller forum is real, currently exists, and that buyers are not wasting their time responding to fake offers, that are actually solicitations for orders of future goods that may not currently exist.

In a preferred object, the GIT System as described above provides goods as Merchandise in Transit (MiT) that can be bought and sold by exchanging payment against shipping documents and other documents that identifies the MiT, at any time before reaching destination, or in some cases, even after reaching a destination. In a preferred object, the GIT System provides the seller and buyer (while MiT is still in transit) to cut stop MiT at some shipping point (such as a transfer point along the shipping route) during shipping and redirect MiT to an alternative destination served by a port or other shipping point included in the initial shipping route. In a preferred object, because redirection is possible to arrange with the shipping company, MiT listed on the GIT System forum are not only goods that are interesting to potential buyers along the initial shipping route, but also to those potential buyers with a direct correspondence to redirect points along the shipping route, thereby broadening the buyer demand for MiT of sellers who list goods on the GIT System forum.

One preferred object of the invention is to provide such a GIT System with software logic providing potential sellers with the ability to quickly locate a narrow field of very interested buyers seeking goods at potential sellers target sales price, for sellers to be able to determine the most profitable sale for their goods, and for sellers to be able to obtain contact information for one or more buyers from that narrow field of potential buyers to provide them with information relating to buyer interest levels and contacts necessary to conclude a more profitable, or most profitable sale.

One preferred object of the invention is to provide such a GIT System and software including a network buyer and seller forum where a seller of goods can first purchase bargain price merchandise that is in transit in a shipping container with an identifiable container number, list such merchandise on the buyer and seller forum that is already in transit or about to be shipped, to resell the merchandise to a buyer who will have the lowest shipping costs, pay the best price, or have both the lowest shipping costs and best price (SIP), where the seller can even redirect the goods to a buyer inside or outside the GIT system to provide goods even quicker to that buyer than might have previously been possible.

### DETAILED DESCRIPTION OF THE INVENTION

The present invention provides an improved local or distributed network computer and communication system permitting sellers to list identified goods in transit or identified goods in storage on a network buyer and seller introductory forum further providing a communication management system for managing certain communications between sellers and potential buyers with respect to such goods, wherein the computer system is loaded with at least one software module having logic permitting anonymous or identifiable sellers to register and list such goods identified by a specific transit container or specific storage container number on the network buyer and seller forum, and the computer system is further loaded with at least one software module having logic permitting anonymous or identifiable registered buyers to compete for the purchasing of such goods.

In a preferred aspect of the above invention, neither the buyer or seller is identified by the buyer and seller forum other than by a transitory identification number until the seller has selected and paid the forum providers, or agreed to pay, for contact information of one or more potential buyers to contact potential buyers for further consideration of one or more offers by one or more potential buyers.

A preferred embodiment of the invention provides such a system, listing and communication forum, that may be referred to as a GIT System, wherein GIT provides a computer system, communication system, and network having the ability to collect, organize, and present offers and bids in a listing forum for Merchandise in Transit (MiT) from registered system users who are potential buyers and sellers. In a more preferred object, Registration with the GIT System is opened to anyone, and the GIT System uses the internet as an interface with its users, but may use other platforms available in the future that provide convenience to users, such a portable communication devices' operating systems and the like.

The GIT System, according to the invention utilizes publicly available or proprietary software programs adapted to allow users of the GIT System to list MiT for sale to potential buyers. In one embodiment, the logic within such software programs or software modules allows sellers to include some or all relevant information about their merchandise, including for example: merchandise description, tracking information (container # and shipping line), documents (shipping documents and other relevant documents such as health certificates, serial numbers, item numbers, invoice numbers and the like), sales and payment condition, restrictions (regions excluded for sale), Port of origin, Estimated Time of Departure, first transshipment port, original estimated time of arrival (ETA) to first transshipment port, final destination port, original ETA to final destination port. In a more preferred aspect, the GIT System provides software logic that also allows sellers to indicate prices CFR (cost and freight) and corresponding destinations where they are ready to sell upon receiving an offer. Software logic of the GIT System can also allow registered sellers to list goods for sale in a buyer/seller forum where potential buyers who are registered users with the GIT System can submit a BOQ and start the purchasing process for the listed goods.

In a preferred embodiment, the GIT System provides one or more software modules or programs with logic permitting sellers to choose among four different types of “listings” to sell merchandise in a buyer/seller forum. Listings may be public or private listing (respectively Public or Closed BOQ listings). If a listing is public, potential buyers can click on the listing ID and see outstanding bids or offers. When a listing is private, outstanding bids or offers are not visible to potential buyers. A listing forum may also be with an Open performance record (OPR) or with a closed performance record (CPR) with respect to potential buyers for listed merchandise (see text below for a description of one type of performance record potential buyer profile). With OPR, the profile of potential buyers who have placed a bid (BOQ) are accessible to the listing seller (visibly posted in the seller's forum access interface or otherwise obtainable by the seller) and seller has the option to request a potential buyer's profile quality to use as input to help the seller with the listing to select a buyer from those who have placed a bid for the listed goods. With CPR, profiles for potential buyers who have placed a BOQ are not accessible to the seller with the listing, so sellers can only select buyers for further contact based upon the BOQs that are placed by the potential buyers.

In a preferred embodiment of the invention, as described above, bids, offers or quotes by potential buyers are only buy offer quotes (BOQ), which are not auction bids as typically thought of in traditional auctions. Instead, the GIT System permits sellers to decide whether to contact a potential buyer who has placed an offer or bid as an offer quote for goods listed on the buyer and seller forum. In this preferred GIT System, according to the invention, the seller is not even required to contact the potential buyer with the largest bid, offer or quote (highest bidder). With this preferred GIT System, sellers with listings are not required to sell listed goods or merchandise to the highest bidder, since many other factors may be considered by the seller with the listing. However, as a practical matter, any seller with a listing would be expected to take the best bid or offer that would result in the greatest profit and least headache for the seller.

In one aspect, the invention provides such a GIT System as described above, which focuses largely on MiT, which can be thought of as merchandise to be soon placed or is already placed in shipping containers with a shipping company for transport to final destination where the merchandise and container are identifiable by a unique ID number. In a more preferred object, the presence of an ID number is central to preferred GIT system services. By focusing on merchandise with IDs and presenting those IDs in the offerings, this GIT System can ensure potential buyers that the merchandise offered for sale in the GIT System buyer and seller forum is real, currently exists, and that buyers are not wasting their time responding to fake offers, that are actually solicitations for orders of future goods that may not currently exist.

In a preferred embodiment, the GIT System as described above provides goods as Merchandise in Transit (MiT) that can be bought and sold by exchanging payment against shipping documents and other documents that identifies the MiT, at any time before reaching destination, or in some cases, even after reaching a destination. In a preferred object, the GIT System provides the seller and buyer (while MiT is still in transit) to cut stop MiT at some shipping point (such as a transfer point along the shipping route) during shipping and redirect MiT to an alternative destination served by a port or other shipping point included in the initial shipping route. In a preferred embodiment, because redirection is possible to arrange with the shipping company, MiT listed on the GIT System forum are not only goods that are interesting to potential buyers along the initial shipping route, but also to those potential buyers with a direct correspondence to redirect points along the shipping route, thereby broadening the buyer demand for MiT of sellers who list goods on the GIT System forum.

In one preferred embodiment, the invention provides such a GIT System with software logic providing potential sellers with the ability to quickly locate a narrow field of very interested buyers seeking goods at potential sellers target sales price, for sellers to be able to determine the most profitable sale for their goods, and for sellers to be able to obtain contact information for one or more buyers from that narrow field of potential buyers to provide them with information relating to buyer interest levels and contacts necessary to conclude a more profitable, or most profitable sale.

In a preferred embodiment, sellers who list their MiT or GiT on a GIT System buyer and seller forum are able to list their merchandise and goods for sale but remain anonymous on the listing. Preferably, sellers are indicated in the forum by a dynamic listing number (a unique ID number associated with a specific seller and goods offered for a specific forum listing). Only seller's performance record may be viewed by potential buyers clicking on the seller's dynamic unique identification number for that particular listing on that buyer and seller forum. In a preferred embodiment, the seller ID is not re-used for the same seller to avoid side dealings that could spoil the reputation and purposes of the GIT System.

Software logic running on this preferred GIT System will permit parties to assess and signal their interest in any offer to the offering party by submitting a bid, offer, or quote (BOQ); by which offering parties (sellers) can review submitted BOQs, select BOQs of interest and contact the parties associated with the selected BOQs to close the transaction without the need for further intermediary GIT System software, but may optionally use part of the GIT System to close and finalize the transaction, or use an authorized service to which the GIT System refers them, such as an escrow type transaction closing service. Software logic of the GIT System may also require the selling party (party who listed goods on the system) to input one or more of the following items in the GIT System in order to continue being able to list goods with the GIT System: (i) whether or not a transaction closed with a party who placed a BOQ on the system, (ii) the DID of the party whom the selling party closed, and (iii) feedback on parties with BOQs that the selling party placed on their DID list.

This preferred GIT System provides software logic and an interface that permits sellers to obtain a disclosure of information regarding the ID of individuals of their liking who place an offer/bid/quote for goods listed by the sellers. (Note that the ID for individual potential buyers is also dynamic and unique to a particular item and offers for a specific listing in the forum.) By clicking on Disclose ID (“DID” or some icon that connects to such features) from one or more of the list of bids/offers/quotes, the seller can add that individual to his disclosed ID list where the identity of the individual who placed the bid/offer/quote as well as their contact information can be disclosed to the seller. A seller's DID list is specifically associated with just one item listing, and each goods or merchandise listing has its DID list. In a preferred embodiment, sellers are not charged the first selected number of times that they include a bidder in their DID list, but are charged a fee for subsequent further inclusions of other bidders. In one embodiment of the invention, sellers are free to contact (outside the GIT system and forum) the bidder that has been added to their DID list in order to conduct business and close the sale.

Software logic running on this preferred GIT System will permit tracking of users' activity. One or both of buyer and seller activities and performance can be tracked and used in the calculation of innovative bidders/sellers profiles (that may or may not be disclosed to users as additional information to select desirable bids/offers/quotes). GIT System services are preferably fee-based service, where sellers are charged fees in order to be able to contact bidders, and bidders are charged fees when they purchase the merchandise for sale. Other fees also apply for certain situations.

A preferred GIT System will to be able to track, organize and report DID activities and transactions, update performance records and charge fees accordingly. Since the transaction is closed without the intermediary of GIT, the organization of those processes is important to ensure that proper incentives are in place for participants to accurately disclose transactions and other activities, thereby allowing the organization providing the GIT System to collect fees and work as an operating concern. GIT System software and system management services will coordinate within the GIT System in a way that ensures fair treatment of all participants by providing multiple auction set-ups and settlements alternatives able to accommodate the different needs of buyers and sellers and a variety of environments. Such features are central for a market place, where concerns or perceptions of fairness and bias can run high and where rules must be devised to enhance clarity and to further reinforce perceptions of stability and impartiality.

In a preferred embodiment, the GIT System provides software with logic to close a DID list for a particular listing on the GIT System forum when a sale has taken place or when time has run out for the listing. In such as case, the DID list is closed either by the seller or by software logic, if the seller forgets to close the DID list. In a particularly preferred embodiment of the invention, GIT System management software logic is running that allows the seller to close their DID LIST by clicking a button. Before doing so, the software logic may require the seller to specify whether a sale for this listing has occurred with respect to one of the buyers in the forum DID LIST. If yes, seller may be required to designate the buyer by checking a box presented by an interface on the GIT Forum or by some other means. In that preferred case, both seller and buyer are charged a transaction fee. If not, then seller is charged only according to the number of bidders added to the DID LIST. By closing the auction, all accounts are settled automatically: fees are calculated and accounts charged. When seller forgets to close the DID LIST a software program may contain logic to automatically do so and to charge any special fees that may apply in that case. The closing process may be automatic and as such, the GIT System can effectively manage large numbers of transactions since it is not necessarily involved in time-consuming sales settlements which involve communication of sales price, payment terms and maybe monitoring of fund transfer.

Such GIT Systems according to the invention will provide great flexibility to both buyers and sellers. In one preferred embodiment of the invention, such a GIT System and software is provided that includes a network buyer and seller forum where a seller of goods can first purchase bargain price merchandise that is in transit in a shipping container with an identifiable container number, anonymously list such merchandise on the buyer and seller forum when the merchandise is already in transit or about to be shipped, to resell the merchandise to a buyer who will have the lowest shipping costs, pay the best price, or have both the lowest shipping costs and pay the best price, where the seller can even redirect the goods to a buyer to provide goods even quicker to the buyer than might have previously been possible. Before the present invention, such was not readily possible.

In an even more preferred embodiment, the GIT System includes and runs software logic that allows sellers to specify one or several prices and destinations for which they are willing to sell the merchandise (delivery price offer, or DPO) without waiting for better bids even if the time for listing the merchandise has not ended. The software logic can make such choices available for potential buyers and provides an option for buyers to place with the forum a bid/offer/quote for the merchandise and destination at those specified prices. That type of offering closing may be called a priority purchase BOQ (PPB) since sellers have decided to sell first to those individuals submitting such offerings. Upon reception of such offers to purchase goods, the GIT System software logic, or a system manager, notifies the seller and the seller then loses the ability to disclose the identity of other bidders until the seller adds the one or more priority purchase bidders to their DID list. In such a preferred embodiment, potential priority purchase buyers have the assurance that sellers cannot ignore their offer to buy without a cost. Either sellers don't add the potential priority purchase buyers to their DID list and lose the ability to contact other bidders who will remain anonymous, or sellers must add the potential priority purchase buyers to their DID list and will have to pay more disclosing ID fees if other bidders are subsequently added to the DID list. That mechanism ensures that sellers have an incentive to make a deal with a priority purchase buyer and make good on their promise to give priority to such buyers, which can add credibility and value to the GIT System.

In one preferred embodiment, sellers can put merchandise in a forum listing on the GIT System, but such sellers are not charged any fee if they choose not to add any bidder to their DID LIST. This unique special feature will allows sellers to run their traditional sale process in parallel and to choose the best bids from either system, with no obligation. Consequently, it will also allows for higher volume of offers (compared to a system that charge a fee just to set up a forum listing or to a system that requires listed merchandise to be sold at the end of a set period of time, optionally if a minimum price is met), making the GIT System a more attractive marketplace for sellers.

In another embodiment, the invention provides an internet listing of existing bulk goods, merchandise, or titled or serialized items for sale that are in transit or are ready for transit, wherein the listing identifies the goods, merchandise, or items by at least two identifiers described in (a) in combination with (b) as follows:

(a) at least one identification of (i) mobile shipping unit number, (ii) container number, (iii) transporting vessel, (iv) shipping papers, or (v) title paper for the goods, merchandise, or items, and

(b) the approximate or exact location at the goods or items at the time of the listing, or at the time when the listing is viewed.

Preferably, the above internet listing described relates to bulk goods for sale that are in transit or are ready for transit and the listing identifies the bulk goods by their (i) container number or (ii) transporting vessel and by the approximate or exact location of the bulk goods at the time of the listing, or at the time when the listing is viewed.

The invention provides in one embodiment, a local or distributed network computer and communication system permitting sellers to access a buyer and seller introductory forum and list goods or titled or serialized items in transit or ready for transit that are identified by at least two identifiers as described in (a) in combination with either (b) or (c) as follows:

(a) at least one of their (i) container number, (ii) transporting vessel, (iii) shipping papers, or (iv) title paper, and

(b) the location of the goods or items at the time of listing, or at the time when the listing is viewed, or

(c) the approximate or exact location of the goods or items when the listing is viewed as determined by utilizing a computer implemented method accessible from information in the listing, and the computer implemented method utilizes software logic and an interface to readily determine an approximate or exact location of the goods or items when the listing is viewed;

and further providing a communication management system for managing certain communications between sellers and potential buyers with respect to such goods, wherein:

the computer system is loaded with at least one software routine with a computer implemented method and logic permitting anonymous sellers to register with the system and list such goods within the network buyer and seller introductory forum,

the computer system is loaded with at least one software routine with a computer implemented method and logic permitting anonymous buyers to compete for purchase of such goods by placing an anonymous bid offer quote that includes separately or collectively a price for the goods and for their delivery to a particular location, which is a preset location or is a new location named by the potential buyer as part of their bid offer quote, and

the computer system is loaded with at least one software routine with a computer implemented method and logic permitting the seller corresponding to a particular listing to access and disclose or obtain contact information for a buyer who has placed an anonymous bid offer quote for the listing according to a particular agreed upon cost structure for the computer system;

and wherein the seller with a listing is not required to accept a bid offer quote from the highest bidder at the end of a particular period of time, or to accept any bid offer quote that is placed in response to a listing.

In a preferred aspect, the above invention provides a system wherein neither the buyer or seller are identified within the buyer and seller introductory forum by other than a transitory identification number until a seller has selected and paid, or agreed to pay, forum providers for contact information of one or more potential buyers to contact potential buyers for further consideration of one or more offers by one or more potential buyers. Preferably, the system includes access to communications providing the listing and other system features with a telephone system, wireless communication system, or another portable communication system.

In a preferred embodiment, the above system lists goods in transit that can be bought and sold by exchanging payment against shipping documents and other documents that identify such merchandise, at any time before reaching destination, or in some cases, even after reaching a destination. This system provides the seller and buyer with software logic and an interface that yields an efficient ability for a seller or buyer to cut short or stop merchandise while it is in transit at some shipping point during its shipping and to redirect the merchandise to an alternative destination served by a port or other shipping point included in the initial shipping route.

In a more preferred embodiment, the system according to the invention provides the seller with software logic and an interface for providing multiple listing for the same goods, providing that the different listings are for delivery of the goods to different locations. This structure permits the seller to determine the best profit available for delivering goods to a particular location after negotiations with shippers, and then have the option of taking an offer from the buyer and seller introductory forum that might accomplish this.

### Some Preferred Embodiment Descriptions

Traders in goods may increase their profitability by engaging in optional sales and using the GIT System. For example, a trader in goods may secure a purchase order from a known customer at a pre-determined price for a predetermined location, while keeping the right to sell that specific merchandise if the seller receives a more profitable offer while the merchandise is in transit to the determined location set out in the purchase order. Using the GIT system, Traders are able to list for sell their merchandise while in transit, by providing listing information describing the merchandise, the shipping itinerary and container number for a large group of potential buyers to see (GIT system is available for all to see on the internet) and then determine the interest of potential buyers with respect to merchandise, timing and location.

By listing goods on the GIT system, the merchandise of a Trader (seller) gets exposure to buyers located in several markets instead of one, and may receive offers more profitable than the original purchase order. In that case, Traders can sell at higher profit using the GIT system. If the GIT system doesn't bring more profitable offer, Traders are not obligated to sell the merchandise and just complete the original transaction with their known customer. In order to make it attractive to that customer, traders will have to compensate him/her with a pre-determined fee or a percentage of the extra profit, for the inconvenience of not knowing if he/she will receive the merchandise.

In a more general way, the GIT System according to the invention allows anyone with MiT to access demand previously inaccessible, for lack of way to find and communicate to interested parties information about their MiT, such as its description, location and container number. Traditional importers who purchased merchandise to resell exclusively to their usual channel of destination, can now list the MiT on the GiT system and may directly receive offers far more profitable that what they would get in their traditional markets. Such offers could arise for example from a local shortage in a market accessible by a swift redirection of the merchandise.

The present invention provides importers with the ability to search and find MiT a few days away from any specified location when they have experienced a high demand for that MiT (merchandise). These importers may then have the opportunity to make a successful offer and obtain goods much more rapidly (or even goods that would otherwise been unavailable) while unusually favorable conditions in the importers' markets persist. It should be noted that importers are not limited to bid on MiT which itinerary includes ports geographically close to importers' markets. Importers may select among all MiT of the desired type that include in their itinerary at least one port where goods can be redirected by trans-shipping to other vessels serving importers' markets.

Before the present invention, locating and making offers on desired MiT that may be most quickly obtained would be a time consuming and very complicated task. This would probably beyond the ability of many importers, because they would need to independently secure and sort a considerable amount of information about merchandise and shipping itineraries. Such information is of the type which many sellers of the merchandise or their brokers may not want to have revealed to unknown parties. Also, sellers and their agents are not likely to give such information to someone for cherry picking of goods (selectively purchasing goods immediately at bargain prices or below market prices when a seller or broker has a limited pool of potential buyers and may be eager to move the items in fear that another buyer cannot be found before the goods will have a reduced value or be worth less due to spoilage and the like). Such goods would be expected to have a higher market price and be more easily sold if more potential buyers simply knew of their existence and had enough information to compete with the person cherry picking and to result in the best sales price for the seller. Alternatively, importers could place a direct order for merchandise in production or in the producer's warehouse and have the merchandise shipped to their markets. The down side of these direct orders is that by the time merchandise would reach the desired destination of the buyer, favorable market conditions might have dissipated. This could also allow enough time for competitors to get their supply from the producers and change the favorable market demand situation.

The following non-limiting examples are provided to better illustrate the invention. Other applications for the elements of this invention will be apparent to people who ordinarily work with multi-media file storage and their transmission.

### EXAMPLES

### Example 1

### Seller or Bidder Profile Listing Example

GIT has invented, purchased, or both software programs having logic that collects information with respect to seller/bidder activity within the GIT System and can report it in a unique format when DID LIST closes.

### Bidder Profile:

In this illustrative embodiment, the profile the bidder profile includes data pertaining to the number of transactions (sales) completed and the rating given by sellers (responsive or irresponsive buyer, as indicated on the seller DID LIST at the time of closing), for two different time horizons. In this example, the time horizons are actions since registration and BOQ and purchase actions taken in the last 90 days.

| | | Since |
|---|---|---|
| Performance as Buyer | Past 90 days | Registration |
| Transactions Completed | 10 | 50 |
| Responsive Buyer | 10 | 50 |
| Unresponsive | 1 | 9 |
| Buyer | | |

### Seller Profile:

In this illustrative embodiment, the seller profile includes data pertaining to the number of transactions completed and the number of IDs (DIDs) added to Disclosed ID List (DID List) by the sellers for two different time horizons. In this example, the time horizons are sales related actions since registration and sales related actions taken in the last 90 days.

| | | Since |
|---|---|---|
| Performance as Seller | Past 90 days | Registration |
| Transactions Completed | 15 | 45 |
| Number of | 28 | 60 |
| Disclosed ID | | |
| Ratio Completed | 54% | 75% |
| Transactions/Disclosed ID | | |

In each embodiment, GIT designs the reporting formats based on the GIT's structure and in a way that is fair to all parties, buyers and sellers. The formats are not evident; and it's a considered choice among many possibilities of which types of information will be useful to buyers and sellers.

### Example 2

### Option Sale Goods Redirect In High Demand Market

In this example, a seller (trader) increases profitability by engaging in optional sales on goods already designated to a customer. In this case, the seller secures a purchase order from a known customer who does not have critical deadlines for receiving the goods or a required arrival date. The goods begin shipment at a pre-determined price for a pre-determined location, while the seller reserves the right in their sales contract to sell the specific merchandise to a different customer (new buyer) and to pay a premium to the first customer (old buyer) if the seller receive a more profitable offer while the merchandise is in transit to that determined location.

Using the GIT system, sellers are able to auction the option sales merchandise while in transit, by listing information describing the merchandise along with the shipping itinerary and container number. This give the seller access for a large group of potential buyers who can see (GIT system is available for all to see on the internet) the listing and determine interest with respect to merchandise, timing and location.. The buyer who sees the listing may have a more urgent need for the goods, or may be willing to pay an even higher purchase price than the option sales contract price to the first buyer.

If the GIT system doesn't bring in a more profitable offer (BOQ), listing sellers are not obligated to sell the merchandise to the buyers of the BOQs, and can just complete the original transaction with their known customer (first buyer). If a BOQ is accepted, the option sales contract can pay a percentage of the extra profit, or a premium amount to the first buyer in order to make the option sales contract attractive to that first customer. In general, sellers will need to compensate the option sales contract buyer with a pre-determined fee or a percentage of the extra profit, for the inconvenience of not knowing if the first buyer will receive the merchandise at the designated shipping arrival date and time.

### Example 3

### High Demand Goods Reselling

In this example, one or more seller (goods investors) increases profitability by buying a set of specifically identified goods already produced, or scheduled to be produced on a given date, such as high demand electronics, games, or early release collector items, and reselling them on the GIT System. In this case, the right to receive the goods, the title paper, or the invoice can be sold on the GIT System, and can even be resold by the purchaser (buyer) who then becomes a seller on the GIT System by re-listing the goods.

The software aspects of the invention can also be embodied as computer readable code on a computer readable media. The computer readable media is any data storage device that can store data which can be thereafter be read by a computer system. Examples of the computer readably media include read-only memory, random-access memory, CD-ROMs, magnetic tape, optical data storage devices. The computer readable media can also be distributed over a network coupled computer systems so that the computer readable code is stored in a distributed fashion.

The present invention may be embodied in specific forms other than those particularly described above or illustrated by the above examples. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and examples, as indicating the scope of the present invention.

I claim:

1. A local or distributed network computer and communication system permitting sellers to list identified goods or merchandise in transit or identified goods or merchandise in storage on a network buyer and seller introductory forum further providing a communication management system for managing certain communications between sellers and potential buyers with respect to such goods, wherein the computer system is loaded with at least one software module having logic permitting anonymous or identifiable sellers to register and list such goods or merchandise identified by a specific transit container or vessel, specific storage container number, or specific mobile shipping unit on the network buyer and seller forum, and the computer system is further loaded with at least one software module having logic permitting anonymous or identifiable registered buyers to compete for purchase of such goods.

2. A local or distributed network computer and communication system according to claim 1, wherein a seller is not required to provide a minimum acceptance price or to accept the highest offer made during a given time period for a listing.

3. A local or distributed network computer and communication system according to claim 1, wherein neither the buyer or seller are identified within the buyer and seller forum by other than a transitory identification number until a seller has selected and paid, or agreed to pay, forum providers for contact information of one or more potential buyers to contact potential buyers for further consideration of one or more offers by one or more potential buyers.

4. A system according to claim 1, wherein the system, listing and communication forum is referred to as a GIT System, and such GIT system provides a computer system, communication system, and network having the ability to collect, organize, and present offers and bids in a listing forum for Merchandise in Transit (MiT) from registered system users who are potential buyers and sellers.

5. A system according to claim 4, wherein registration with the GIT System is not restricted, is available to any first time user, and the GIT System uses the internet or another system that provides acceptable communication as an interface with its users.

6. A system according to claim 5, wherein the GIT system includes communications with a telephone system, wireless communication system, or another portable communication system.

7. A system according to claim 4, wherein the GIT System provides a buyer and seller forum for merchandise in transit, wherein merchandise and container are identifiable by a unique ID number.

8. A system according to claim 7, wherein the GIT System lists goods as merchandise in transit that can be bought and sold by exchanging payment against shipping documents and other documents that identify such merchandise, at any time before reaching destination, or in some cases, even after reaching a destination.

9. A system according to claim 8, wherein the GIT System provides the seller and buyer with software logic and an interface that yields an efficient ability for a seller or buyer to cut short or stop merchandise while it is in transit at some shipping point during its shipping and to redirect the merchandise to an alternative destination served by a port or other shipping point included in the initial shipping route.

10. A system according to claim 4, wherein the GIT System includes software logic providing potential sellers with the ability to quickly locate a narrow field of very interested buyers seeking goods at potential sellers target sales price, for sellers to be able to determine the most profitable sale for their goods, and for sellers to be able to obtain contact information for one or more buyers from that narrow field of potential buyers to provide them with information relating to buyer interest levels and contacts necessary to conclude a more profitable, or most profitable sale for such goods.

11. A system according to claim 4, where users can submit bid offer quotes that are made of two components, a price and a location in relation to the price where merchandise should be delivered without incurring other charges.

12. An internet listing of existing bulk goods or merchandise, or titled or serialized items, for sale that are in transit or are ready for transit, wherein the listing identifies the goods, merchandise or items by at least two identifiers described in (a) in combination with (b) as follows:
(a) at least one identification of (i) mobile shipping unit number, (ii) container number, (iii) transporting vessel, (iv) shipping papers, or (v) title paper for the goods, merchandise, or items, and
(b) the approximate or exact location at the goods, merchandise or items at the time of the listing, or at the time when the listing is viewed.

13. An internet listing of existing according to claim 12, with bulk goods or merchandise for sale that are in transit or are ready for transit and the listing identifies the bulk goods or merchandise by their (i) mobile shipping unit number, (ii) container number or (iii) transporting vessel and also by the approximate or exact location of the bulk goods or merchandise at the time of the listing, or at the time when the listing is viewed, wherein the merchandise referred to in the listing may be one or more empty shipping containers or mobile shipping units.

14. A local or distributed network computer and communication system permitting sellers to access a buyer and seller introductory forum and list goods or merchandise, or titled or serialized items, that are in transit or that are ready for transit, which are identified by at least two identifiers as described in (a) in combination with either (b) or (c) as follows:
(a) at least one of their (i) mobile shipping unit number, (ii) container number, (iii) transporting vessel, (iv) shipping papers, or (v) title paper, and
(b) the location of the goods, merchandise, or items at the time of listing, or at the time when the listing is viewed, or
(c) the approximate or exact location of the goods, merchandise or items when the listing is viewed as determined by utilizing a computer implemented method accessible from information in the listing, and the computer implemented method utilizes software logic and an interface to readily determine an approximate or exact location of the goods, merchandise, or items when the listing is viewed;
and further providing a communication management system for managing certain communications between sellers and potential buyers with respect to such goods, merchandise or items, wherein:
the computer system is loaded with at least one software routine with a computer implemented method and logic permitting anonymous sellers to register with the system and list such goods, merchandise, or items within the network buyer and seller introductory forum,
the computer system is loaded with at least one software routine with a computer implemented method and logic permitting anonymous buyers to compete for purchase of such goods, merchandise, or items by placing an anonymous bid offer quote that includes separately or collectively a price for the goods, merchandise or items and for their delivery to a particular location, which is a preset location or is a new location named by the potential buyer as part of their bid offer quote, and
the computer system is loaded with at least one software routine with a computer implemented method and logic permitting the seller corresponding to a particular listing to access and disclose or obtain contact information for a buyer who has placed an anonymous bid offer quote for the listing according to a particular agreed upon cost structure for the computer system;
and wherein the seller with a listing is not required to accept a bid offer quote from the highest bidder at the end of a particular period of time, or to accept any bid offer quote that is placed in response to a listing.

15. A system according to claim 14, wherein neither the buyer or seller are identified within the buyer and seller introductory forum by other than a transitory identification number until a seller has selected and paid, or agreed to pay, forum providers for contact information of one or more potential buyers to contact potential buyers for further consideration of one or more offers by one or more potential buyers.

16. A system according to claim 14, wherein the system includes access to communications to provide the user with the listing and other system features through the use of a telephone system, wireless communication system, or another portable communication system.

17. A system according to claim 14, wherein the system lists goods, merchandise or items in transit that can be bought and sold by exchanging payment against shipping documents and other documents that identify such merchandise, at any time before reaching destination, or in some cases, even after reaching a destination.

18. A system according to claim 17, wherein the system provides the seller and buyer with software logic and an interface that yields an efficient ability for a seller or buyer to cut short or stop goods, merchandise or items while they are in transit at some shipping point during its shipping and to redirect the goods, merchandise or items to an alternative destination served by a port or other shipping point included in the initial shipping route.

19. A system according to claim 14, wherein the system provides the seller and buyer with software logic and an interface that may require the seller to at least view and disclose the identification of a particular buyer corresponding to a special buy offer quote, but not necessarily require the seller to contact that disclosed buyer, in order for the seller for a listing to obtain disclosure of contact information for any other buyers who have placed a buy offer quote for a particular listing.

20. A system according to claim 14, wherein the system provides the seller with software logic and an interface for providing multiple listing for the same goods, merchandise or items, providing that the different listings are for delivery of the goods, merchandise or items to different locations.
